(19) United States
(12) Patent Application Publication
(10) Pub. No.: US 2007/0080597 A1
(43) Pub. Date: Apr. 12, 2007

(54) Motor and manufacturing method thereof

(75) Inventors: Mikitsugu Suzuki, Hoi-gun (JP); Yoshihito Nishikawa, Toyohashi-city (JP)

Correspondence Address: POSZ LAW GROUP, PLC, 12040 SOUTH LAKES DRIVE, SUITE 101, RESTON, VA, 20191, US

(73) Assignee: ASMO CO., LTD., Kosai-city (JP)

(21) Appl. No.: 11/541,772

(22) Filed: Oct. 3, 2006

(30) Foreign Application Priority Data
Oct. 6, 2005 (JP) 2005-293922

(51) Int. Cl. H02K 1/27; H02K 5/24

(52) U.S. Cl. 310/156.47; 310/68 B; 310/51; 310/156.25; 310/156.12

(57) ABSTRACT

A motor includes an annular magnet and an annular core. The annular core is placed radially inward of the annular magnet and includes a plurality of annular core segments. At least one of axially opposed surfaces of one or more annular core segments includes an annular recess, which is configured according to an inertia of an annular core and is coaxial with an outer peripheral edge of the annular core segment. A shaft extends through a through hole of the annular core and is fixed to the annular core.

### CROSS REFERENCE TO RELATED APPLICATION

This application is based on and incorporates herein by reference Japanese Patent Application No. 2005-293922 filed on Oct. 6, 2005 and Japanese Patent Application No. 2006-235456 filed on Aug. 31, 2006.

### BACKGROUND OF THE INVENTION

1. Field of the Invention

The present invention relates to a motor and a manufacturing method thereof.

2. Description of Related Art

In general, an inertia of a rotor of a brushless motor needs to be set according to a specification of the individual motor. A technique for reducing the inertia is disclosed in, for example, Japanese Unexamined Patent Publication No. H09-275652. According to Japanese Unexamined Patent Publication No. H09-275652, a plurality of axial holes are provided to the rotor core to reduce the weight of the rotor and thereby to reduce the inertia of the rotor.

Furthermore, there is known another technique for reducing a cogging torque by skewing a magnet of the rotor. For example, Japanese Unexamined Patent Publication No. H10-285848 discloses a permanent magnet type motor, which has a rotor core made of a plurality of core segments. A ring magnet is fixed integrally to an outer peripheral part of each core segment. The core segments are installed to a rotatable shaft to integrally assemble the rotor. In this rotor, the adjacent ring magnets are circumferentially displaced from each other by a predetermined angle, so that the ring magnets as a whole are skewed.

However, in the case of the permanent magnet type motor recited in Japanese Unexamined Patent Publication No. H09-275652, when the positions of the through holes are not appropriately set in conformity with the positions of the permanent magnets, the circumferential magnetic balance is disadvantageously lost. Furthermore, with respect to the permanent magnet type motor of Japanese Unexamined Patent Publication No. H10-285848, in which the core segments and the ring magnets are simply integrated and are fixed to the rotatable shaft, in a case where the desired inertia of the rotor differs from one type of motor to another type of motor, the plurality of core segments, which are set to achieve the corresponding desired inertia of the rotor, need to be prepared for each of the different types of motors. Therefore, the components cannot be universal to the different types of motors, and thereby the number of components is disadvantageously increased, resulting in an increase in the manufacturing costs.

### SUMMARY OF THE INVENTION

The present invention addresses the above disadvantages. Thus, it is an objective of the present invention to provide a motor and a manufacturing method thereof, which alleviates at least one of the above disadvantages.

To achieve the objective of the present invention, there is provided a motor, which includes a stator and a rotor. The rotor is radially opposed to the stator and includes an annular magnet, an annular core and a shaft. The annular magnet includes a plurality of annular magnet segments, which are coaxial to each other. The annular core is placed radially inward of the annular magnet and has a through hole that penetrates axially therethrough. The annular core includes a plurality of annular core segments, which have a generally identical shape and are coaxial to each other. At least one of axially opposed surfaces of each annular core segment includes an annular recess, which is configured according to an inertia of the annular core and is coaxial with an outer peripheral edge of the annular core segment. The shaft extends through the through hole of the annular core and is fixed to the annular core.

To achieve the objective of the present invention, there is also provided a motor, which includes a stator and a rotor. The rotor is radially opposed to the stator and includes an annular magnet, an annular core and a shaft. The annular magnet includes a plurality of annular magnet segments, which are coaxial to each other. The annular core is placed radially inward of the annular magnet and has a through hole that penetrates axially therethrough. The annular core includes at least two types of annular core segments, which are coaxial to each other. At least one of axially opposed surfaces of at least one of the at least two types of annular core segments includes an annular recess, which is coaxial with an outer peripheral edge of the annular core segment and is configured such that the at least two types of annular core segments have at least two types of inertias. The shaft extends through the through hole of the annular core and is fixed to the annular core.

To achieve the objective of the present invention, there is also provided a manufacturing method of a motor. According to the manufacturing method, each of a plurality of annular core segments, each of which has a generally identical shape, is fixed to an inner peripheral side of a corresponding one of a plurality of annular magnet segments to integrate the annular core segment and the annular magnet segment into an integrated body. Then, an annular recess is formed in at least one of axially opposed surfaces of the annular core segment of each integrated body in such a manner that the annular recess is configured according to an inertia of an annular core of a rotor and is coaxial with an outer peripheral edge of the annular core segment. Next, each integrated body is installed to a shaft of the rotor after the forming of the annular recess. Then, the rotor is assembled relative to a stator in a housing of the motor after the installing of each integrated body.

To achieve the objective of the present invention, there is also provided a manufacturing method of a motor. According to the manufacturing method, an annular recess is formed in at least one of axially opposed surfaces of each of a plurality of annular core segments, each of which has a generally identical shape, in such a manner that the annular recess is configured according to an inertia of an annular core of a rotor and is coaxial with an outer peripheral edge of the annular core segment. Then, each annular core segment is fixed to an inner peripheral side of a corresponding one of a plurality of annular magnet segments to integrate the annular core segment and the annular magnet segment into an integrated body after the forming of the annular recess. Next, each integrated body is installed to a shaft of the rotor after the fixing of each annular core segment. Next, the rotor is assembled relative to a stator in a housing of the motor after the installing of each integrated body.

To achieve the objective of the present invention, there is also provided a manufacturing method of a motor. According to the manufacturing method, each of at least two types of annular core segments is fixed to an inner peripheral side of a corresponding one of a plurality of annular magnet segments to integrate the annular core segment and the annular magnet segment into an integrated body. Then, the annular recess is formed in at least one of axially opposed surfaces of at least one of the at least two types of annular core segments in such a manner that the annular recess is coaxial with an outer peripheral edge of the annular core segment and is configured such that the integrated bodies, which include the at least two types of annular core segments, have at least two types of inertias. Next, each integrated body is installed to a shaft of a rotor after the forming of the annular recess. Then, the rotor is assembled relative to a stator in a housing of the motor after the installing of each integrated body.

To achieve the objective of the present invention, there is also provided a manufacturing method of a motor. According to the manufacturing method, an annular recess is formed in at least one of axially opposed surfaces of at least one of at least two types of annular core segments in such a manner that the annular recess is coaxial with an outer peripheral edge of the annular core segment and is configured such that the at least two types of annular core segments have at least two types of inertias. Then, each annular core segment is fixed to an inner peripheral side of a corresponding one of a plurality of annular magnet segments to integrate the annular core segment and the annular magnet segment into an integrated body after the forming of the annular recess. Next, each integrated body is installed to a shaft of a rotor after the fixing of each annular core segment. Then, the rotor is assembled relative to a stator in a housing of the motor after the installing of each integrated body.

### BRIEF DESCRIPTION OF THE DRAWINGS

The invention, together with additional objectives, features and advantages thereof, will be best understood from the following description, the appended claims and the accompanying drawings in which:

FIG. 1 is a schematic cross sectional view of a brushless motor according to an embodiment of the present invention;

FIG. 2 is a cross sectional view of a rotor of the brushless motor shown in FIG. 1;

FIG. 3 is an exploded view of the rotor of the brushless motor shown in FIG. 1;

FIGS. 4A and 4B are descriptive views showing a core segment of the rotor shown in FIG. 2;

FIG. 5 is a descriptive view showing a magnet of the rotor shown in FIG. 2;

FIGS. 6A to 6C are descriptive views showing manufacturing steps of the rotor shown in FIG. 2;

FIG. 7 is a descriptive view showing a manufacturing step of the rotor shown in FIG. 2;

FIGS. 8A to 8B are descriptive views showing a manufacturing step of the rotor shown in FIG. 2;

FIG. 9 is a cross sectional view, which is similar to FIG. 2 but shows a modification of the rotor;

FIG. 10 is a cross sectional view, which is similar to FIG. 2 but shows another modification of the rotor;

FIG. 11 is a cross sectional view, which is similar to FIG. 2 but shows another modification of the rotor;

FIG. 12 is a cross sectional view, which is similar to FIG. 2 but shows another modification of the rotor;

FIG. 13 is a cross sectional view, which is similar to FIG. 2 but shows another modification of the rotor;

FIG. 14 is a descriptive view showing a modification of the core segment; and

FIG. 15 is a descriptive view showing a modification of the magnet of the rotor.

### DETAILED DESCRIPTION OF THE INVENTION

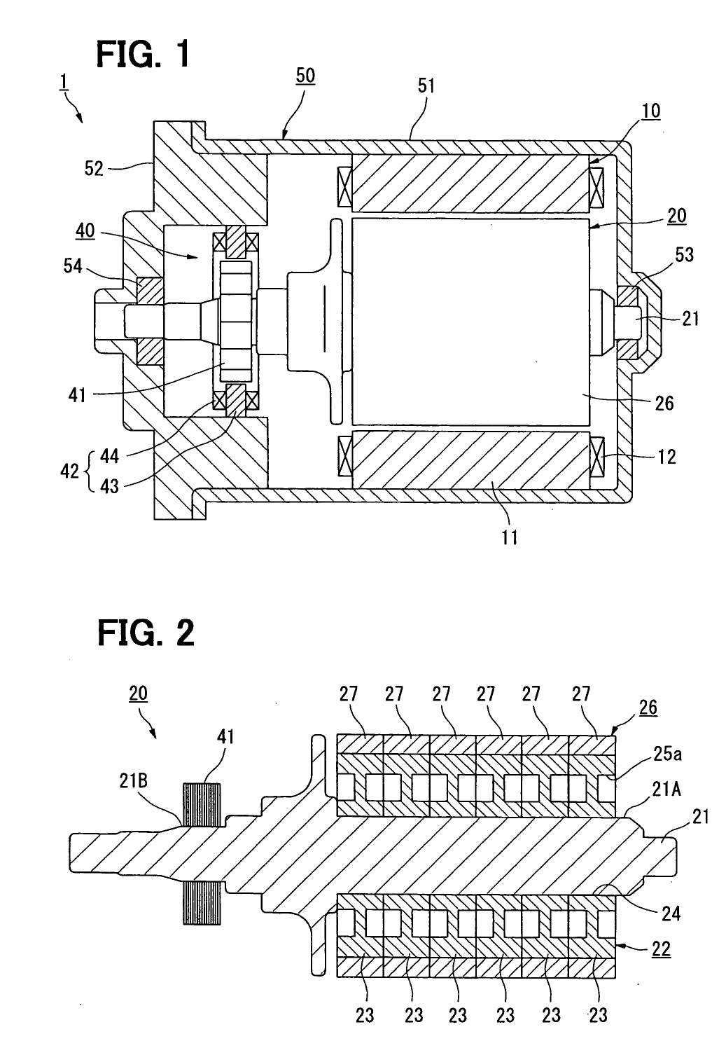

An embodiment of the present invention, in which the present invention is implemented in a brushless motor 1, will be described. With reference to FIG. 1, the brushless motor 1 is of an inner rotor type and includes a stator 10, a rotor 20 and a housing 50 as its main components. The rotor 20 is rotatably supported at a location radially inward of the stator 10. The housing 50 receives the stator 10 and the rotor 20. In the brushless motor 1 of the present embodiment, a resolver 40 is provided to sense a rotational position of the rotor 20.

The stator 10 of the present embodiment includes a stator core 11 and a winding 12. The stator core 11 is fixed to an inner peripheral wall of a cup-shaped housing main body 51 of the housing 50. The winding 12 is wound around the stator core 11. The stator core 11 of the present embodiment is formed by stacking a plurality of core sheets made of silicon steel plates one after another. The stator core 11 includes an annular outer core part and a plurality of teeth. The teeth are arranged at generally equal angular intervals in the circumferential direction of the outer core part and radially inwardly project from the outer core part. The winding 12 is wound around the teeth.

The rotor 20 of the present embodiment includes a shaft 21, an annular core 22, a ring-shaped (annular) magnet 26 and a resolver rotor 41. The annular core 22 is made of a magnetic material and is installed to the shaft 21. The ring-shaped magnet 26 is installed to an outer peripheral surface of the core 22. A resolver rotor 41 is installed to an output side (the left side in FIG. 1) of the shaft 21.

The housing 50 of the present embodiment includes the cup-shaped housing main body 51 and an end plate 52. The end plate 52 closes an opening of the housing main body 51. Bearings 53, 54, which rotatably support the shaft 21, are provided to the housing main body 51 and the end plate 52, respectively. A resolver stator 42, which constitutes a part of the resolver 40, is fixed to the end plate 52. Although not depicted, a power supply device, which supplies a drive voltage from an external power source to the winding 12 of the stator 10, and a resolver connector, which is connected to a winding 44 of the resolver stator 42, are provided to the end plate 52.

As shown in FIG. 1, when the stator 10 and the rotor 20 are placed inside the housing 50, the annular stator 10 and the magnet 26 of the rotor 20 are radially opposed to each other in such a manner that a small air gap is formed therebetween.

Furthermore, in this state, the annular resolver stator 42 and the resolver rotor 41 are radially opposed to each other in such a manner that a small air gap is formed therebetween. The resolver stator 42 and the resolver rotor 41 form the resolver 40 of a variable-reluctance type, which senses the rotational position of the rotor 20 of the brushless motor 1.

The resolver rotor 41 is formed by stacking a plurality of core sheets one after another. Each core sheet is formed by stamping a thin metal plate material.

The resolver stator 42 includes a generally annular core 43 and the winding 44. The winding 44 is wound around the core 43. The core 43 is formed by stacking a plurality of core sheets one after another. Each core sheet is formed by stamping a thin metal plate material.

In the thus constructed brushless motor 1, when the drive voltage is supplied from a drive circuit (not shown) to the stator 10 through the power supply device, a rotational magnetic filed is created in the stator 10. Through the magnetic interaction between the thus created rotating magnetic field and the magnet 26, the rotor 20 is rotated.

Specifically, a gap permeance, which is formed by the resolver rotor 41 and the resolver stator 42 in the resolver 40, changes in a sine wave form in response to the rotation of the resolver rotor 41. The resolver 40 outputs this measurement signal to the drive circuit through the resolver connector (not shown). The drive circuit senses the rotational position of the rotor 20 based on this measurement signal and supplies the drive voltage to the predetermined winding 12 according to the sensed rotational position of the rotor 20. In this way, the stator 10 can generate the rotating magnetic field, which corresponds to the rotational speed (the rotational position) of the rotor 20.

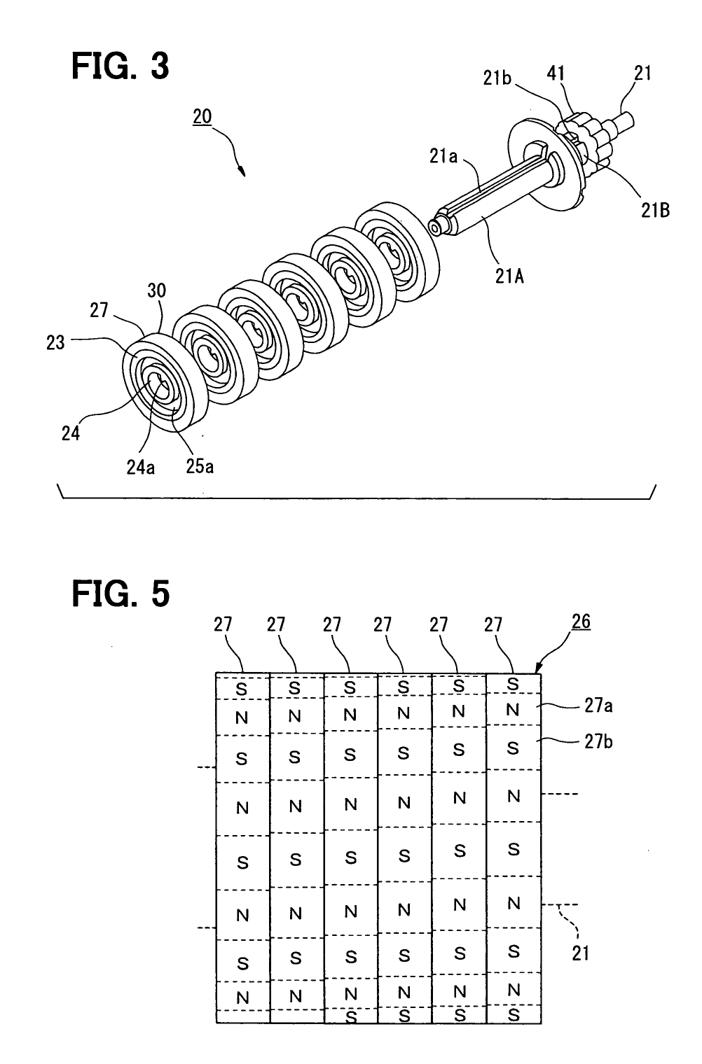

Next, the rotor 20 of the present embodiment will be described with reference to FIGS. 2 and 3.

The shaft 21 of the present embodiment includes a core installation part 21A and a resolver rotor installation part 21B. The core 22 is installed to the core installation part 21A, and the resolver rotor 41 is installed to the resolver rotor installation part 21B. An axial groove 21a is formed in the core installation part 21A. A projection (more specifically, axially aligned projections of core segments) 24a of the core 22 is engaged with the groove 21a, so that the core 22 is positioned relative to the shaft 21 and is limited from rotation relative to the shaft 21. Furthermore, an axial groove 21b is formed in the resolver rotor installation part 21B. A projection, which is formed in an installation hole of the resolver rotor 41, is engaged with the groove 21b, so that the resolver rotor 41 is positioned relative to the shaft 21 and is limited from rotation relative to the shaft 21.

In the rotor 20 of the present embodiment, a plurality (six in the present embodiment) of core segments 23 and a plurality of (six in the present embodiment) of magnet segments 27 are coaxially connected to form the core 22 and the magnet 26, respectively. Specifically, each core segment 23 is an annular member, which is made of a magnetic material, and the corresponding ring-shaped (annular) magnet segment 27 is fitted to an outer peripheral part of the core segment 23. Therefore, the core segment 23 and the magnet segment 27 are integrated into an integrated body 30. Then, these integrated bodies 30 are press fitted to the shaft 21.

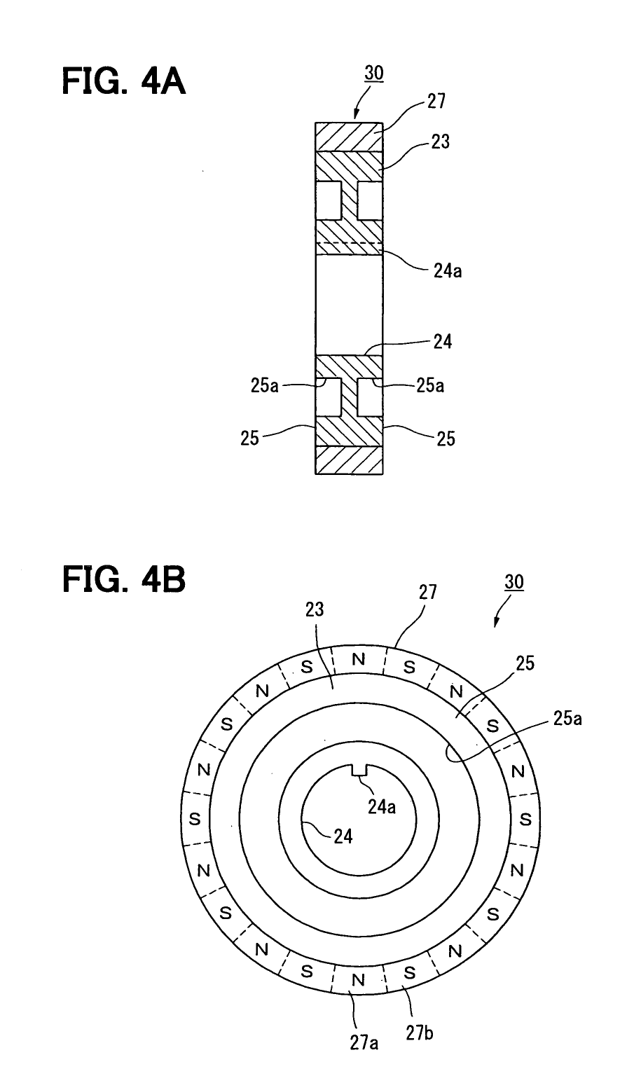

As shown in FIGS. 4A and 4B, an axial through hole 24 is formed through each core segment 23, and the projection 24a is formed in the inner peripheral surface of the through hole 24 to project radially inward. An annular recess 25a is formed in each of axially opposed surfaces (hereinafter referred to as toric surfaces) of each core segment 23, which extend perpendicular to the axial direction of the core segment 23. The recess 25a is formed as an annular groove, which is coaxial with an outer peripheral edge of the core segment 23 and extends continuously in the circumferential direction. Specifically, every radially outer end point of the recess 25a is equispaced from the outer peripheral edge of the core segment 23, and every radially inner end point of the recess 25a is equispaced from the outer peripheral edge of the core segment 23. The two recesses 25a are provided to the axially opposed toric surfaces 25, respectively, of each core segment 23. An axial depth and a radial width of each recess 25a are set based on inertia of the rotor 20.

Each ring-shaped magnet segment 27 includes ten magnetized regions (first type magnetized regions) 27a and ten magnetized regions (second type magnetized regions) 27b, which are alternately arranged in the circumferential direction. The magnetized regions 27a, 27b are formed by circumferentially dividing the magnet segment 27 into twenty equal regions, each of which is magnetized to the corresponding predetermined polarity. Each magnetized region 27a is magnetized such that a magnetic flux outputted from the magnetized region 27a at an outer peripheral surface of the magnetized region 27a is directed radially outward. Furthermore, each magnetized region 27b is magnetized such that a magnetic flux outputted from the magnetized region 27b is directed radially inward.

As shown in FIG. 2, the recesses 25a of all of the core segments 23 of the rotor 20 of the present embodiment are formed as the annular recesses of the generally identical configuration (the generally identical outer diameter, the generally identical inner diameter and the generally identical axial depth). When the rotor 20 is formed by the above core segments 23, which have the generally identical recesses 25a, the components of the rotor 20 may become common or universal among different types of motors.

Furthermore, as shown in FIG. 5, in the state where the core segments 23, which are integrated with the magnet segments 27, are fixed to the shaft 21, the magnetized regions 27a, 27b in one of each axially adjacent two magnet segments 27 are displaced from the magnetized regions 27a, 27b of the other one of each axially adjacent two magnet segments 27 by a predetermined angle in the circumferential direction in the rotor 20 of the present embodiment. Specifically, in the magnet 26 of the present embodiment, the phases of the magnetized regions 27a, 27b are displaced by the predetermined angle in the circumferential direction, so that the magnetic poles (the S magnetic pole columns and the N magnetic pole columns) of the magnet 26 are skewed with respect to the rotational axis of the rotor 20. In this way, the cogging torque generated at the time of operating the brushless motor 1 can be reduced according to the present embodiment.

According to the present embodiment, in order to skew the magnetic poles (the S magnetic pole columns and the N magnetic pole columns), the magnet segments 27 are circumferentially displaced one after another by the predetermined angle with respect to a reference position (the projection 24a serves as the reference position in the present embodiment) of the core segment 23 at the time of press fitting the core segments 23 to the magnet segments 27 to integrate them. In this way, when the integrated bodies 30 of the core segments 23 and the magnet segments 27 are fixed to the shaft 21, the magnetic poles (the S magnetic pole columns and the N magnetic pole columns) are skewed with respect to the axis of the rotor 20.

Next, a manufacturing method of the brushless motor 1 will be described.

In the case of the brushless motor 1, after fixing the stator 10 into the housing main body 51, the rotor 20, which is formed in a rotor manufacturing process described below, is assembled (a rotor assembling process) into the housing main body 51. Thereafter, the end plate 52, to which the resolver stator 42 is installed, is assembled to the housing main body 51.

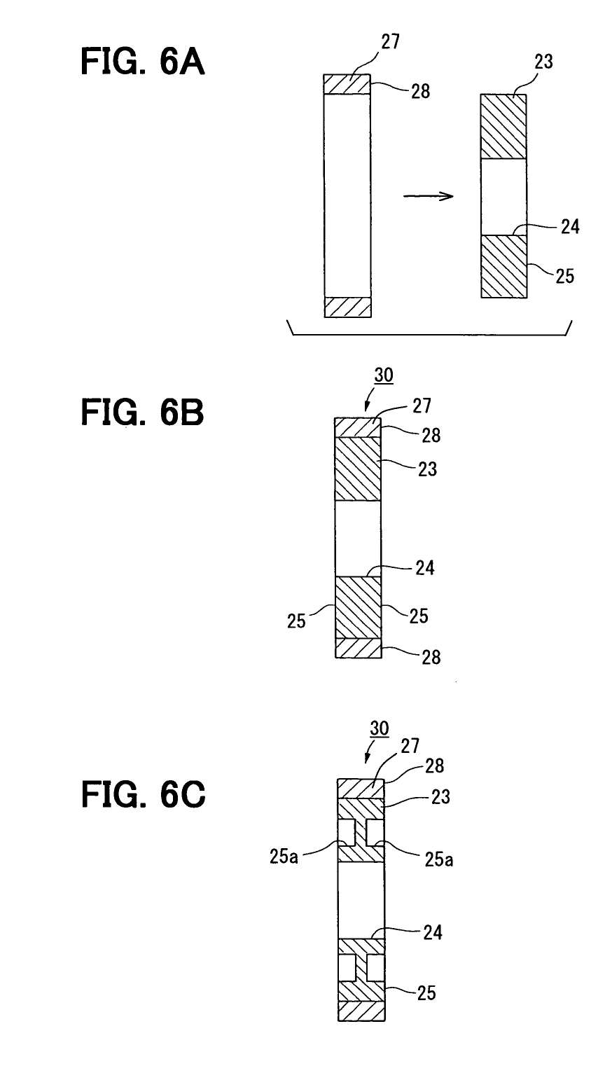

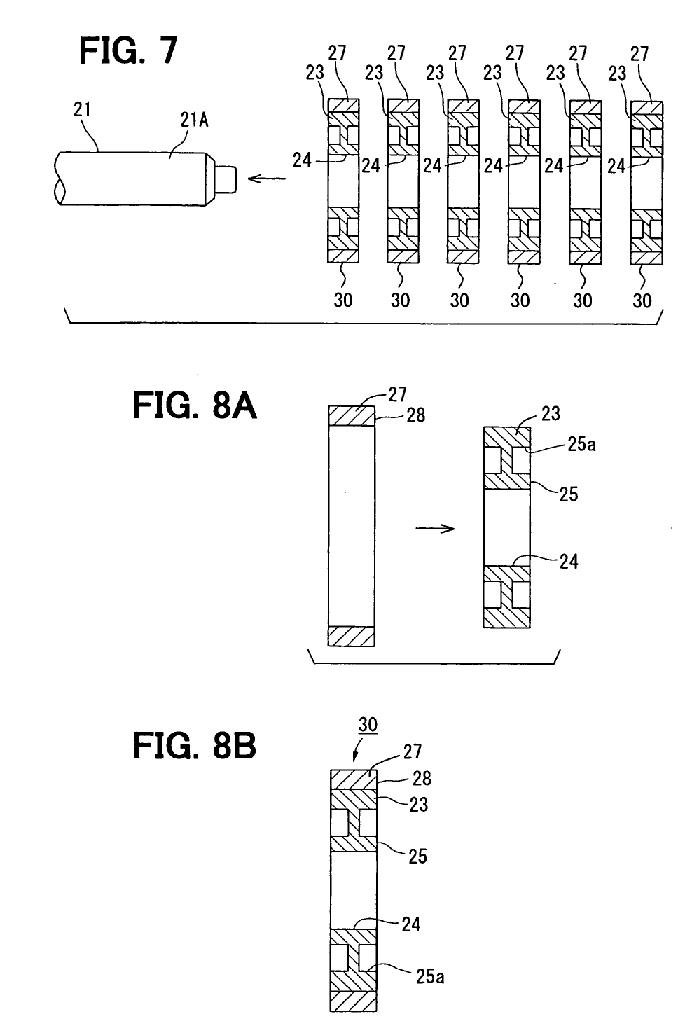

Next, the rotor manufacturing process, which is performed before installation of the rotor 20 into the housing main body 51, will be described with reference to FIGS. 6A to 7.

First, as shown in FIG. 6A, each core segment 23 is securely press fitted into the corresponding ring-shaped magnet segment 27 (a magnet installation step). At the time of the press fitting, the magnetic segments 27 are positioned relative to the core segments 23 in such a manner that the magnet segments 27 are circumferentially displaced one after another by the predetermined angle with respect to the reference position of the core segments 23.

In an alternative case where the magnetic poles (the S magnetic pole columns and the N magnetic pole columns) are not skewed, i.e., extend linearly in a direction parallel to the axis of the rotor 20, the magnet segments 27 are not displaced one after another in the circumferential direction with respect to the reference position of the core segments 23, so that the relative position between the magnet segment 27 and the core segment 23 is the same in all of the integrated bodies 30.

An axial thickness of the core segment 23 and an axial thickness of the magnet segment 27 are generally the same. Thus, as shown in FIG. 6B, in the press fitted state, each toric surface 28 of the magnet segment 27 becomes flush with the adjacent toric surface 25 of the core segment 23.

In the step shown in FIGS. 6A and 6B, the recesses 25a are not yet formed in the toric surfaces 25 of the core segments 23.

In the present embodiment, after the integration of the core segment 23 and the magnet segment 27, each of the axially opposed toric surfaces 25 of the core segment 23 is cut by machining to form the annular recess 25a, which is coaxial with the outer peripheral edge of the core segment 23 (a recess forming step). In the present embodiment, the two annular recesses 25a are cut simultaneously in the axially opposed two toric surfaces 25 of the core segment 23. Thus, a required cutting time period can be reduced to one half in comparison to a case where a single recess, which has an axial depth that is two times greater than the axial depth of the above recess 25a, is formed only in one of the two toric surfaces of the core segment 23 to achieve the same inertia. In this way, the processing time period, which is required in the recess forming step, can be shortened according to the present embodiment.

In the recess forming step of the present embodiment, the recesses 25a of all of the core segments 23 of the rotor 20 are formed as the annular recesses of the generally identical configuration (the generally identical outer diameter, the generally identical inner diameter and the generally identical axial depth). When the recesses 25a of all of the core segments 23 are set to have the generally identical configuration, it is not required to change the settings in the recess forming step, so that the recess forming step can be simplified.

Thereby, there are provided the integrated bodies 30, each of which includes the magnet segment 27 and the core segment 23 having the generally identical recesses 25a. Then, as shown in FIG. 7, these integrated bodies 30 are sequentially press fitted to the core installation part 21A of the shaft 21 through a distal end of the shaft 21 (a core installing step). In this way, the core 22 is installed to the shaft 21, and the magnet 26, which has the skewed magnetic poles (the skewed S magnetic pole columns and the skewed N magnetic pole columns), is provided at the outer peripheral surface of the core 22.

In the brushless motor 1 of the present embodiment, the six core segments 23 and the six magnet segments 27 are coaxially connected to form the rotor 20. However, the present invention is not limited to this construction. For example, more than or less than six core segments 23 and more than or less than six magnet segments 27 may be coaxially connected to form the rotor 20 according to the size of the shaft 21.

Specifically, regardless of the axial size of the rotor 20, the core segments 23 and the magnet segments 27 can be commonly used. Therefore, according to the present embodiment, through use of the common core segments 23 and the common magnet segments 27, it is possible to implement various brushless motors, which are produced according to different design specifications, without increasing the types of components of the motors. As described above, when the core segments 23 and the magnet segments 27 are commonly used, the component management costs can be reduced, thereby allowing a reduction in the manufacturing costs.

Furthermore, in a case where the inertia of the rotor 20 needs to be adjusted, the size (e.g., the radial width, the axial depth) of the recess 25a in each core segment 23 may be changed to change the inertia of the rotor 20.

According to the manufacturing method of the motor according to the above embodiment, at the magnet installation step, the magnet segment 27 and the core segment 23, in which the recesses 25a are not yet formed, are securely press fitted together to form the integrated body 30. Thereafter, at the recess forming step, the recesses 25a are cut in the core segment 23. However, the present invention is not limited to this. For example, the above manufacturing method of the motor may be modified in a manner depicted in FIGS. 8A and 8B.

Specifically, as shown in FIG. 8A, in this modification, the recesses 25a are preformed in the core segment 23, and the core segment 23, in which the recesses 25a are formed, is press fitted to the magnet segment 27 to form the integrated body 30, as shown in FIG. 8B. In the case where the recesses 25a are preformed in the core segment 23, the recesses 25a may be formed by cutting or pressing or may be preformed by metal mold casting.

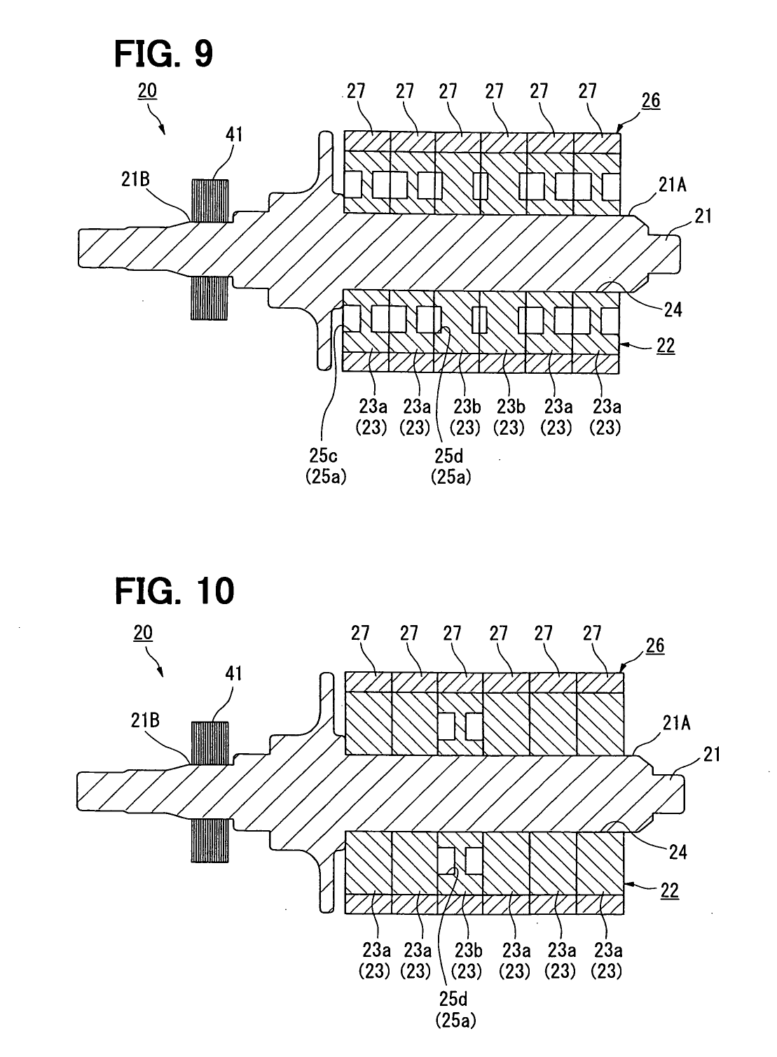

Next, structural modifications of the motor will be described. FIGS. 9 to 13 show the cross sectional views, which are similar to that of FIG. 2 but are of modifications of the rotor of the brushless motor. In the following description, the components similar to those of the above embodiment will be indicated by the same numerals and will not be described further.

The core 22 of the rotor 20 according to the modification shown in FIG. 9 are made of two types of core segments 23 (23a, 23b), which include two types of recesses 25a (25c, 25d), respectively. The outer diameter and the inner diameter of each of the recesses 25c, 25d are generally the same, but the axial depth of the recess 25c is larger than the axial depth of the recess 25d to implement different inertias. In other words, the different recesses 25c, 25d are formed in the core segments 23a, 23b, which have the same axial thickness, so that the weight of the core segment 23a and the weight of the core segment 23b differ from each other to change the inertia between the core segment 23a and the core segment 23b. When the two types of core segments 23a, 23b, which have different inertias, are combined, the inertia of the entire rotor 20 can be more finely adjusted in comparison to the case where the core segments of the single type are used. Thereby, the inertia can be more easily adjusted to the desired value.

In the core 22 of the present modification, six core segments 23 (23a, 23b) are used, and the two types of core segments 23a, 23b have the two different inertias. Thus, there are 64 possible combinations (i.e., the sixth power of 2). As a result, it is possible to provide the various motors, each of which may have one of 64 possible inertias. The number of the core segments 23 (i.e., the number of divided parts of the core 22) and the number of possible inertias of the core segments 23 implemented by the recess shape are not limited to above number and can be any number equal to or greater than 2. In such a case, when the number of divisions of the core is denoted as “m”, and the number of types of inertias of the core segments is denoted as “n”, a total number of possible combinations of the inertias of the rotor will be “n”th power of “m”.

Next, a manufacturing method of the brushless motor 1 will be described. The manufacturing method of the brushless motor 1 of this modification includes the rotor assembling process and the magnet installation step of the rotor manufacturing process, which are the same as those described with reference to FIGS. 6A to 7 of the above embodiment and therefore will not be described further.

Similar to the motor manufacturing method of the above embodiment described with reference to FIGS. 6A to 7, after the integration of the core segment 23 and the magnet segment 27 in the magnet installation step, each of the axially opposed toric surfaces 25 of the core segment 23 is cut by machining to form the annular recess 25a, which is coaxial with the outer peripheral edge of the core segment 23 (the recess forming step).

In the recess forming step of the present modification, the two different types of core segments 23a, 23b are formed by forming the two different types of annular recesses 25c, 25d, which have the different configurations, to implement the two different types of core segments 23 of the rotor 20, which have the different inertias.

The thus formed core segments 23a, 23b, each of which has one of the two types of recesses 25c, 25d, are integrated with the magnet segments 27 to form the integrated bodies 30, and these integrated bodies 30 are sequentially press fitted to the core installation part 21A of the shaft 21 through the distal end of the shaft 21 (the core installation step). In this way, the core 22 is installed to the shaft 21, and the magnet 26, which has the magnetic poles (the S magnetic pole columns and the N magnetic pole columns) that are skewed with respect to the axis of the rotor 20, is provided in the outer peripheral surface of the core 22. Therefore, there is implemented the motor, which includes the rotor 20, which has the two types of core segments 23a, 23b. The types of recesses formed in the recess forming step are not limited to the above ones, and three or more types of recesses or a single type of recess shown in FIG. 10, which depicts another modification, may be formed in the recess forming step.

In the modification of FIG. 9, the two types of core segments 23a, 23b include the two types of recesses 25c, 25d, respectively. However, here, the different types of core segments 23a, 23b are only required to have the different inertias, respectively. Thus, as shown in FIG. 10, a plurality of core segments 23a, each of which has no recess in its toric surfaces, may be combined with only one recessed core segment 23b, which has the recesses 25d in its toric surfaces, respectively, to form the core 22. In the case of FIG. 10, only the one recessed core segment, which has the recesses, is provided. However, the number of the recessed core segment(s) is not limited to one and may be two or more depending on the desired inertia.

According to the manufacturing method of the motor in the above modification, in the magnet installation step, the core segments 23, each of which not yet has the recesses 25c, 25d, are securely press fitted to the magnet segments 27 to form the integrated bodies 30, and then the recesses 25c, 25d are individually cut in the core segments 23 in the recess forming step. Alternatively, the two types of recesses 25c, 25d may be preformed in the core segments 23 to implement two types of inertias, and then the core segments 23 (23a, 23b) may be press fitted to the magnet segments 27 to form the integrated bodies 30, like in the manufacturing method of the motor described with reference to FIG. 8. In the case where the recesses 25c, 25d are preformed in the core segment 23, the recesses 25c, 25d may be formed by cutting or pressing or may be preformed by metal mold casting. Furthermore, the types of recesses, which are preformed in the core segments 23, are not limited to the two types and may be modified to be one or three or more types as long as there are provided the core segments 23, which have two or more different types of inertias.

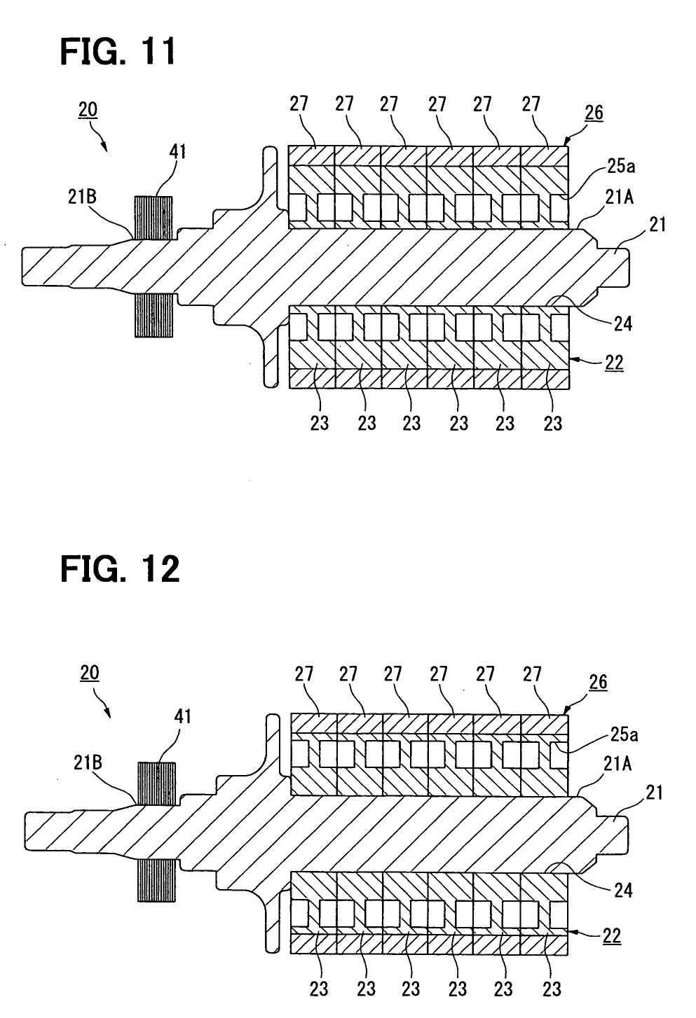

FIG. 11 shows another modification, in which the recesses 25a are displaced closer to the inner peripheral edge of the corresponding core segment 23, i.e., closer to the shaft 21 (closer to the axis of the rotor 20). Specifically, in the above embodiment and modifications, each recess 25a, which is formed in the core segment 23, is generally radially centered between the radially inner edge and the radially outer edge of the core segment 23. However, in the modification shown in FIG. 11, each recess 25a is placed closer to the inner peripheral edge of the core segment 23 (closer to the shaft 21) than the outer peripheral edge of the core segment 23. That is to say that the center of mass of the core segment 23 is shifted to the outer peripheral edge side to increase the inertia in comparison to the above described ones.

In another modification shown in FIG. 12, the recesses 25a are displaced closer to the outer peripheral edge of the corresponding core segment 23, i.e., closer to the corresponding magnet segment 27. Specifically, each recess 25a is placed closer to the outer peripheral edge of the core segment 23 (closer to the magnet segment 27) than the inner peripheral edge of the core segment 23. That is to say that the center of mass of the core segment 23 is shifted to the inner peripheral edge side to reduce the inertia in comparison to the above described ones.

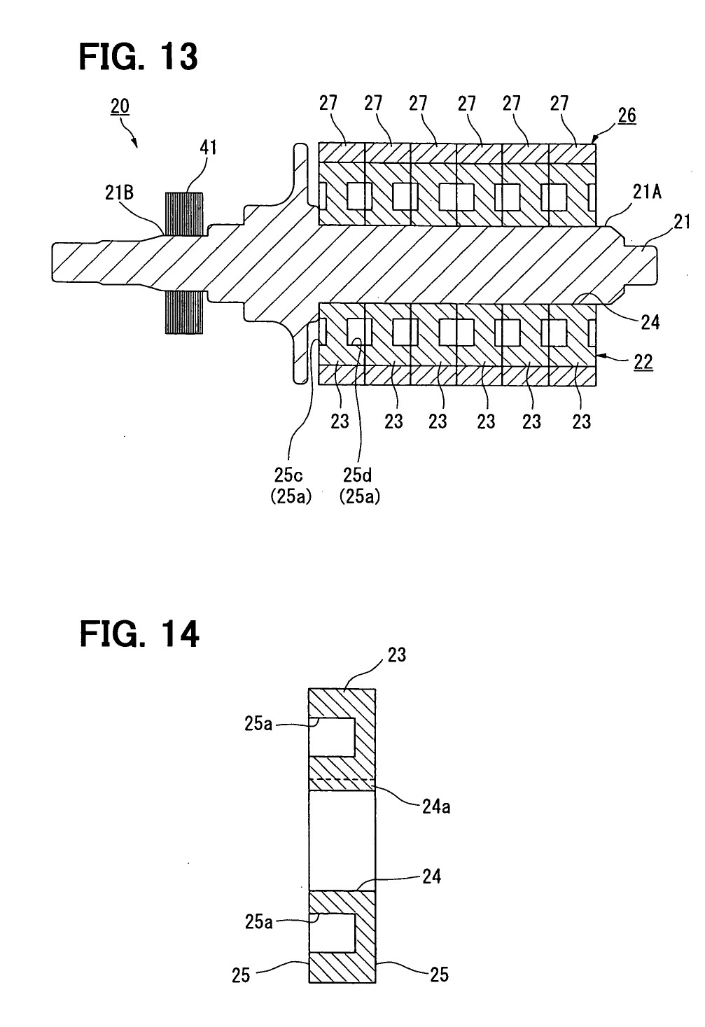

Furthermore, in another modification shown in FIG. 13, at the time of forming the recesses 25a in the axially opposed toric surfaces 25 of each core segment 23, the recesses 25a are replaced with recesses 25c, 25d, which have different axial depths, respectively.

In the above embodiment and modifications, the axial depth of the recess is changed to change the inertia. Alternatively, the radial width of the recess may be changed to achieve the desired inertia. In such a case, the positions of the core segments should be determined in view of the balance of the entire rotor.

In the above embodiment, the recesses 25a are formed in the axially opposed toric surfaces 25 of the core segment 23. Alternatively, as shown in FIG. 14, the recess 25a may be formed only in one of the axially opposed toric surfaces 25 of the core segment 23. The recess 25a of this modification shown in FIG. 14 has the outer diameter and the inner diameter, which are the same as those of the recess 25a of the above embodiment. However, the axial depth of the recess 25a of this modification shown in FIG. 14 is increased generally two times in comparison to that of the above embodiment. Even when the core segments 23, each of which has the recess 25a only in one of the axially opposed toric surfaces, are used, the inertia of the rotor 20 can be set to the desired value.

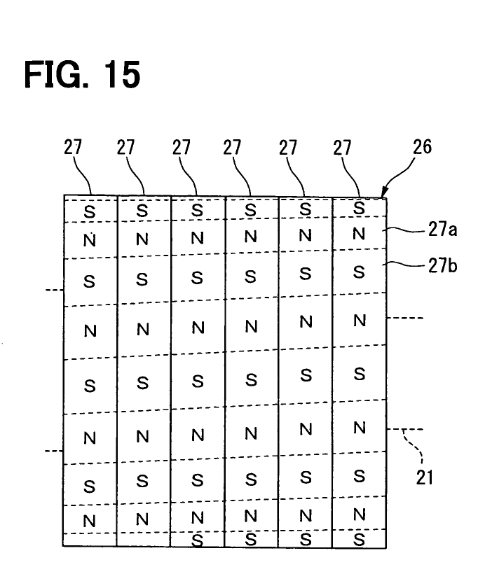

Furthermore, in the above embodiment and modifications, each of the magnetized regions 27a, 27b extends parallel to the axis of the rotor 20. Alternatively, as shown in FIG. 15, each of the magnetized regions 27a, 27b may be tilted in conformity with the angle of the skewing with respect to the axis of the rotor 20. Specifically, in the above embodiment and modifications, each of the magnetized regions 27a, 27b has a generally rectangular shape when the magnetized region 27a, 27b is viewed from the side. However, in the modification shown in FIG. 15, each of the magnetized regions 27a, 27b has a generally parallelogram shape. When the magnetized regions 27a, 27b are formed in conformity with the angle of the skewing, the magnetic change caused by the rotation of the motor is smoothed to further reduce the cogging torque.

Additional advantages and modifications will readily occur to those skilled in the art. The invention in its broader terms is therefore not limited to the specific details, representative apparatus, and illustrative examples shown and described.

What is claimed is:

1. A motor comprising a stator and a rotor, wherein the rotor is radially opposed to the stator and includes:
an annular magnet that includes a plurality of annular magnet segments, which are coaxial to each other;
an annular core that is placed radially inward of the annular magnet and has a through hole that penetrates axially therethrough, wherein:
the annular core includes a plurality of annular core segments, which have a generally identical shape and are coaxial to each other; and
at least one of axially opposed surfaces of each annular core segment includes an annular recess, which is configured according to an inertia of the annular core and is coaxial with an outer peripheral edge of the annular core segment; and
a shaft that extends through the through hole of the annular core and is fixed to the annular core.

2. The motor according to claim 1, wherein the annular recess is formed in each of the axially opposed surfaces of each annular core segment.

3. The motor according to claim 1, wherein:
an outer peripheral surface of each annular magnet segment includes a plurality of first type magnetized regions and a plurality of second type magnetized regions, which are alternately arranged in a circumferential direction of the annular magnet segment;
each of the plurality of first type magnetized regions of each annular magnet segment is magnetized such that a magnetic flux, which is outputted from the first type magnetized region, is directed radially outward;
each of the plurality of second type magnetized regions of each annular magnet segment is magnetized such that a magnetic flux, which is outputted from the second type magnetized region, is direction radially inward; and
the plurality of first type magnetized regions and the plurality of second type magnetized regions of one of each axially adjacent two of the plurality of annular magnet segments are circumferentially displaced by a predetermined angle from the plurality of first type magnetized regions and the plurality of second type magnetized regions of the other one of each axially adjacent two of the plurality of annular magnet segments.

4. A motor comprising a stator and a rotor, wherein the rotor is radially opposed to the stator and includes:
an annular magnet that includes a plurality of annular magnet segments, which are coaxial to each other;
an annular core that is placed radially inward of the annular magnet and has a through hole that penetrates axially therethrough, wherein:
the annular core includes at least two types of annular core segments, which are coaxial to each other; and
at least one of axially opposed surfaces of at least one of the at least two types of annular core segments includes an annular recess, which is coaxial with an outer peripheral edge of the annular core segment and is configured such that the at least two types of annular core segments have at least two types of inertias; and
a shaft that extends through the through hole of the annular core and is fixed to the annular core.

5. The motor according to claim 4, wherein the annular recess is formed in each of the axially opposed surfaces of the at least one of the at least two types of annular core segments.

6. The motor according to claim 4, wherein:
an outer peripheral surface of each annular magnet segment includes a plurality of first type magnetized regions and a plurality of second type magnetized regions, which are alternately arranged in a circumferential direction of the annular magnet segment;
each of the plurality of first type magnetized regions of each annular magnet segment is magnetized such that a magnetic flux, which is outputted from the first type magnetized region, is directed radially outward;
each of the plurality of second type magnetized regions of each annular magnet segment is magnetized such that a magnetic flux, which is outputted from the second type magnetized region, is direction radially inward; and
the plurality of first type magnetized regions and the plurality of second type magnetized regions of one of each axially adjacent two of the plurality of annular magnet segments are circumferentially displaced by a predetermined angle from the plurality of first type magnetized regions and the plurality of second type magnetized regions of the other one of each axially adjacent two of the plurality of annular magnet segments.

7. A manufacturing method of a motor, comprising:
fixing each of a plurality of annular core segments, each of which has a generally identical shape, to an inner peripheral side of a corresponding one of a plurality of annular magnet segments to integrate the annular core segment and the annular magnet segment into an integrated body;
forming an annular recess in at least one of axially opposed surfaces of the annular core segment of each integrated body in such a manner that the annular recess is configured according to an inertia of an annular core of a rotor and is coaxial with an outer peripheral edge of the annular core segment;
installing each integrated body to a shaft of the rotor after the forming of the annular recess; and
assembling the rotor relative to a stator in a housing of the motor after the installing of each integrated body.

8. The manufacturing method according to claim 7, wherein the forming of the annular recess includes forming the annular recess in each of the axially opposed surfaces of the annular core segment of each integrated body.

9. The manufacturing method according to claim 7, wherein the installing of each integrated body to the shaft includes positioning each integrated body in such a manner that a plurality of first type magnetized regions and a plurality of second type magnetized regions of one of each axially adjacent two of the plurality of annular magnet segments are circumferentially displaced by a predetermined angle from a plurality of first type magnetized regions and a plurality of second type magnetized regions of the other one of each axially adjacent two of the plurality of annular magnet segments.

10. A manufacturing method of a motor, comprising:
forming an annular recess in at least one of axially opposed surfaces of each of a plurality of annular core segments, each of which has a generally identical shape, in such a manner that the annular recess is configured according to an inertia of an annular core of a rotor and is coaxial with an outer peripheral edge of the annular core segment;
fixing each annular core segment to an inner peripheral side of a corresponding one of a plurality of annular magnet segments to integrate the annular core segment and the annular magnet segment into an integrated body after the forming of the annular recess;
installing each integrated body to a shaft of the rotor after the fixing of each annular core segment; and
assembling the rotor relative to a stator in a housing of the motor after the installing of each integrated body.

11. The manufacturing method according to claim 10, wherein the forming of the annular recess includes forming the annular recess in each of the axially opposed surfaces of each annular core segment.

12. The manufacturing method according to claim 10, wherein the installing of each integrated body to the shaft includes positioning each integrated body in such a manner that a plurality of first type magnetized regions and a plurality of second type magnetized regions of one of each axially adjacent two of the plurality of annular magnet segments are circumferentially displaced by a predetermined angle from a plurality of first type magnetized regions and a plurality of second type magnetized regions of the other one of each axially adjacent two of the plurality of annular magnet segments.

13. A manufacturing method of a motor, comprising:
fixing each of at least two types of annular core segments to an inner peripheral side of a corresponding one of a plurality of annular magnet segments to integrate the annular core segment and the annular magnet segment into an integrated body;
forming an annular recess in at least one of axially opposed surfaces of at least one of the at least two types of annular core segments in such a manner that the annular recess is coaxial with an outer peripheral edge of the annular core segment and is configured such that the integrated bodies, which include the at least two types of annular core segments, have at least two types of inertias;
installing each integrated body to a shaft of a rotor after the forming of the annular recess; and
assembling the rotor relative to a stator in a housing of the motor after the installing of each integrated body.

14. The manufacturing method according to claim 13, wherein the forming of the annular recess includes forming the annular recess in each of the axially opposed surfaces of the at least one of the at least two types of annular core segments.

15. The manufacturing method according to claim 13, wherein the installing of each integrated body to the shaft includes positioning each integrated body in such a manner that a plurality of first type magnetized regions and a plurality of second type magnetized regions of one of each axially adjacent two of the plurality of annular magnet segments are circumferentially displaced by a predetermined angle from a plurality of first type magnetized regions and a plurality of second type magnetized regions of the other one of each axially adjacent two of the plurality of annular magnet segments.

16. A manufacturing method of a motor, comprising:
forming an annular recess in at least one of axially opposed surfaces of at least one of at least two types of annular core segments in such a manner that the annular recess is coaxial with an outer peripheral edge of the annular core segment and is configured such that the at least two types of annular core segments have at least two types of inertias;
fixing each annular core segment to an inner peripheral side of a corresponding one of a plurality of annular magnet segments to integrate the annular core segment and the annular magnet segment into an integrated body after the forming of the annular recess;
installing each integrated body to a shaft of a rotor after the fixing of each annular core segment; and
assembling the rotor relative to a stator in a housing of the motor after the installing of each integrated body.

17. The manufacturing method according to claim 16, wherein the forming of the annular recess includes forming the annular recess in each of the axially opposed surfaces of the at least one of the at least two types of annular core segments.

18. The manufacturing method according to claim 16, wherein the installing of each integrated body to the shaft includes positioning each integrated body in such a manner that the plurality of first type magnetized regions and the plurality of second type magnetized regions of one of each axially adjacent two of the plurality of annular magnet segments are circumferentially displaced by a predetermined angle from the plurality of first type magnetized regions and the plurality of second type magnetized regions of the other one of each axially adjacent two of the plurality of annular magnet segments.
